(19) United States
(12) Patent Application Publication
(10) Pub. No.: US 2018/0041059 A1
(43) Pub. Date: Feb. 8, 2018

(54) MULTI-PURPOSE STORAGE CONTAINER HAVING COVER FOR CHARGING STAND

(71) Applicant: MARK & DRAW INC, SEOUL (KR)

(72) Inventor: TEAKJIN CHOI, Seoul (KR)

(21) Appl. No.: 15/227,843

(22) Filed: Aug. 3, 2016

(51) Int. Cl. H02J 7/00; B65D 25/02; B65D 43/02

(52) U.S. Cl. CPC H02J 7/0044; B65D 43/0202; B65D 25/02

(57) ABSTRACT

A multi-purpose storage container includes a container body, having a sidewall and a bottom, for receiving a power strip and a charging adaptor; a cover for covering a top opening of the container body wherein a charging stand for an electronic device is formed on the cover; and a storage compartment, constructed to be removably received in the container body. A side opening is formed on the sidewall of the container body so that a power cable can pass through the side opening. In addition, the charging stand includes a groove formed on a top of the cover to receive the electronic device. Sound generated by the electronic device can pass through a plurality of holes formed on the groove. Then, the sound passes through a sound transmitting portion of the container body. Preferably, the sound transmitting portion includes a plurality of holes.

### FIELD OF THE INVENTION

The present invention relates to a multi-purpose storage container having a charging stand for an electronic device on its cover, more particularly to a multi-purpose storage container having a container body, a cover, and a storage compartment. The multi-purpose storage container can contain a power strip and/or a charging adapter for supplying a power source to the electronic device, and it has a charging stand on the cover for charging the electronic device such as a mobile phone, smart phone, tablet computer, mp3 player, and so forth. The storage compartment of the multi-purpose storage container can store stationery such as writing instruments, erasers, glue, sticky notes, and so forth.

### BACKGROUND OF THE INVENTION

People usually use their items such as stationery, a power strip, a charging adapter, and an electronic device on their desk for personal or business use. Many people use a desk organizer to organize stationery like writing instruments, pens, erasers, glue, sticky notes, and the like. Currently, many people use a charging station or charger for an electronic device such as mobile phone, smart phone, tablet computer, mp3 player, and the like. In addition, a cord container or organizer is intended for organizing a power source such as a power strip, a power cord wire, a charging adapter, or the like, for using the computer and electronic devices. To help organize those items, a number of products are on the market such as organizers, containers, and charging stations, for consumers and businesses. Even if those products are used to organize or charge items for personal or business use on the desk, those products still need to be organized for efficient use on the desk. Also, if such items are not well organized, they may cause inconvenience or poor work performance. Thus, there is a need for a container having integrated structures and functions for organizing, storing, and containing items, and charging electronic devices easily and conveniently for a user.

Furthermore, an electronic device, such as mobile phones, smart phones, tablet computers, and the like, has become popular and widely used for communication, entertainment, and other purposes. These electronic devices need to be charged to be used and thus there are many charging stations in the market. Those charging stations have different charging connectors depending on the electronic device or operating system. Thus, if, in the user's lifetime, a user changes the electronic device using a different operating system or the electronic device is made by different manufacturer, the user may need to change the charging station for charging the different electronic devices.

Therefore, to solve such problems and facilitate several functions together to conveniently organize items, such as stationery, a power strip, a charging adapter, and an electronic device, there is a need for a multi-purpose storage container for storing stationery and having a charging station for electronic devices, having a compact, stylish, and integrated structure of a container, a cover having a charging stand and a storage compartment. This invention is directed to solve these problems and satisfy the long-felt need.

### SUMMARY OF THE INVENTION

The present invention contrives to solve the disadvantages of the prior art. The present invention provides a multi-purpose storage container having a charging stand for an electronic device on its cover, and more particularly, a multi-purpose storage container having a container body, a cover, and a storage compartment. The multi-purpose storage container can contain a power strip and/or a charging adapter for supplying a power source for the electronic device, and provides a charging stand on the cover for charging an electronic device such as a mobile phone, smart phone, tablet computer, mp3 player, and so forth. The storage compartment of the multi-purpose storage container can store stationery such as writing instruments, erasers, glue, sticky notes, and so forth.

The object of the invention is to provide a multi-purpose storage container, including: a container body, having a sidewall and a bottom, for receiving a power strip and a charging adaptor; a cover for covering a top opening of the container body wherein a charging stand for an electronic device is formed on the cover; and a storage compartment, constructed to be removably received in the container body. A side opening is formed on the sidewall of the container body so that a power cable can pass through the side opening.

Another object of the invention is to provide a multi-purpose storage container, including: a container body, having a sidewall and a bottom, for receiving a power strip and a charging adaptor, wherein the sidewall comprises a front sidewall and a rear sidewall both of which face each other; a cover for covering a top opening of the container body wherein a charging stand for an electronic device is formed on the cover; and a storage compartment, constructed to be removably received in the container body, having a plurality of sub-compartments, wherein a side opening is formed on the rear sidewall of the sidewall of the container body so that a power cable can pass through the side opening, wherein a sound-transmitting portion is formed on an upper portion of the front sidewall of the sidewall of the container body so that sound generated by the electronic device can pass through the plurality of holes.

Still another object of the invention is to provide a multi-purpose storage container, having a charging stand for an electronic device formed on the cover of the multi-purpose storage container. A groove formed on a top of the cover receives the electronic device therein and sound generated by the electronic device can pass through a plurality of holes formed on the groove. Then, the sound passes through a sound transmitting portion of the container body. Preferably, the sound transmitting portion includes a plurality of holes.

The advantages of the present invention are: (1) the multi-purpose storage container of the present invention, having a container body, a cover with a charging station, and a storage compartment, has a well designed and integrated structure for multi-purposes such as organizing and storing items, such as stationery, a charging adapter, and a power strip, and charging an electronic device; (2) the charging stand of the cover of the present invention can provide a stand for charging the electronic device, such as mobile phones, smart phones, tablet computers, securely or conveniently received in a groove on top of the cover of the present invention; (3) holes on the groove and the sound transmitting portion of the present invention allow transmission of sound generated from the electronic device, reducing the sound attenuation in the container body; (4) the storage compartment of the present invention can provide sub-compartments of various sizes so that stationery of various sizes, such as writing instrument, erasers, glue, sticky notes, and so forth, can be conveniently stored therein; (5) the storage compartment and the cover having the charging stand of the present invention can easily be attached or detached to the container body; (6) a power strip or a charging adapter for supplying a power to the electronic device is safely stored or organized in the container body of the present invention, so that a damage from spilling liquid on the power strip or the charging adapter can be prevented by the structure of the container body; (7) the multi-purpose storage container of the present invention has a compact, stylish, and integrated structure; and (8) the container body, the storage compartment, or the cover having the charging stand can be molded by a single molding such as an injection molding, and thus, it is easy to manufacture the multi-purpose storage container and the manufacturing cost is low.

Although the present invention is briefly summarized, a fuller understanding of the invention can be obtained by the following drawings, detailed descriptions, and appended claims.

### BRIEF DESCRIPTION OF THE DRAWINGS

These and other features, aspects, and advantages of the present invention will become better understood with reference to the accompanying drawings, wherein:

FIG. 1 shows a perspective view of a multi-purpose storage container having a storage compartment and a charging stand according to one embodiment of the present invention;

FIG. 2 shows a perspective view of a container body and a storage compartment of the multi-purpose storage container assembled together according to one embodiment of the present invention;

FIG. 3 shows a front view of the container body and the storage compartment of the multi-purpose storage container assembled together in FIG. 2;

FIG. 4 shows a rear view of the container body of the multi-purpose storage container;

FIG. 5 shows a top plan view of the container body of the multi-purpose storage container;

FIG. 6 shows a cross sectional view of the multi-purpose storage container containing a power strip and a charging adapter for an electronic device;

FIG. 7 shows an exploded view of the multi-purpose storage container of the present invention;

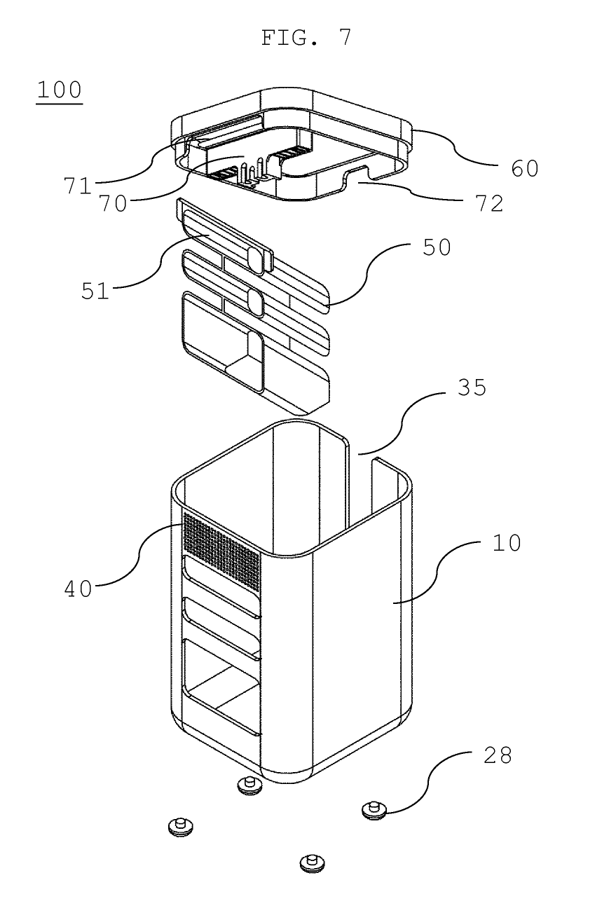

FIG. 8 shows a bottom plan view of the multi-purpose storage container of the present invention;

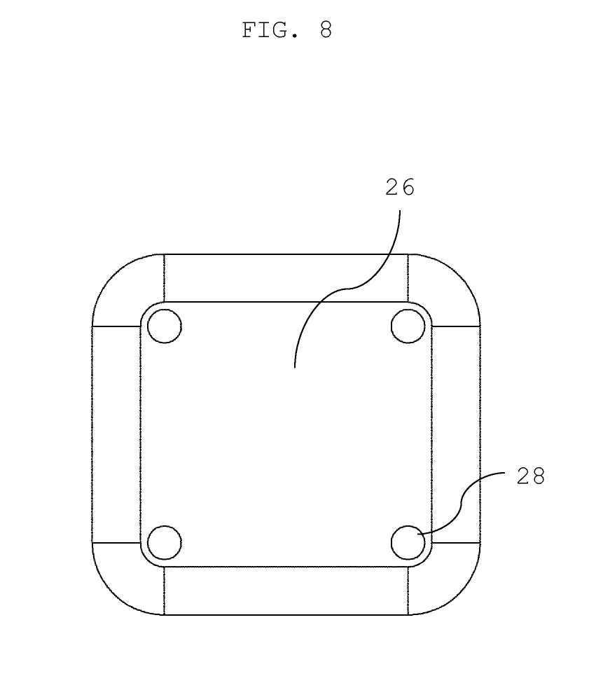

FIG. 9 shows a perspective view of the cover having the charging station;

FIG. 10 shows a top plan view of the cover having the charging station;

FIG. 11 shows a perspective view of the storage compartment of the multi-purpose storage container of the present invention;

FIG. 12 shows a perspective view of use of the multi-purpose storage container containing stationery stored in the storage compartment and the electronic device received in the charging stand of the cover; and

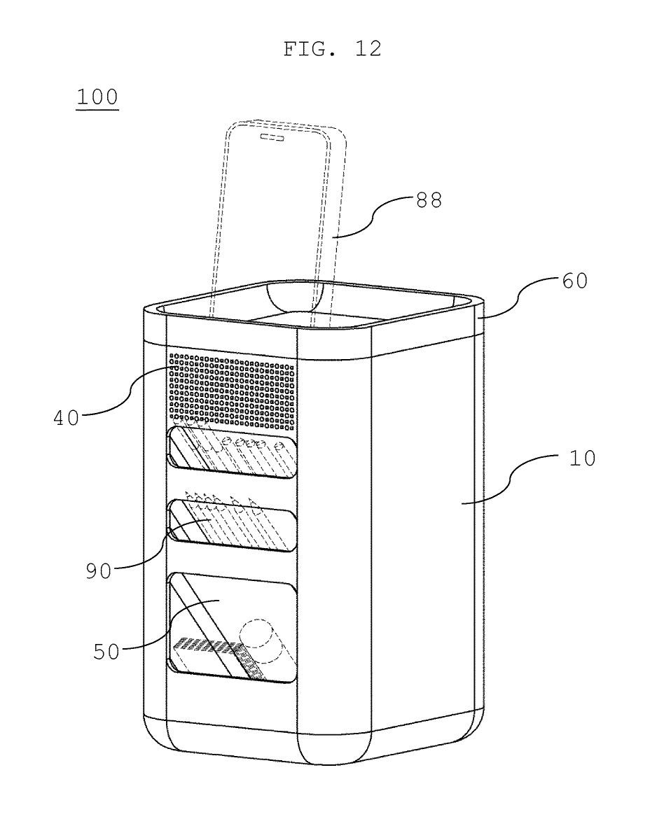

FIG. 13 shows a cross sectional view the container body of the multi-purpose storage container.

### DETAILED DESCRIPTION EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions, or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about”, it will be understood that the particular value forms another embodiment.

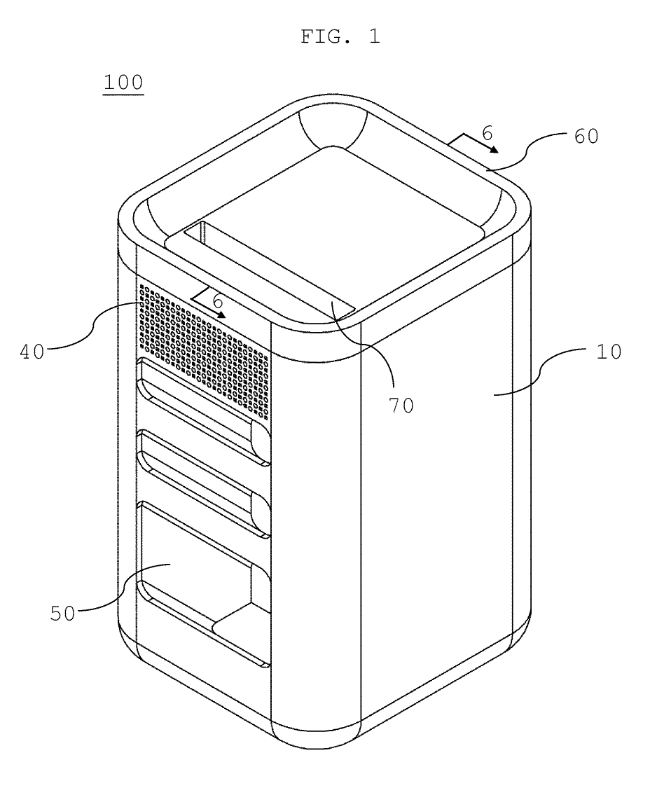

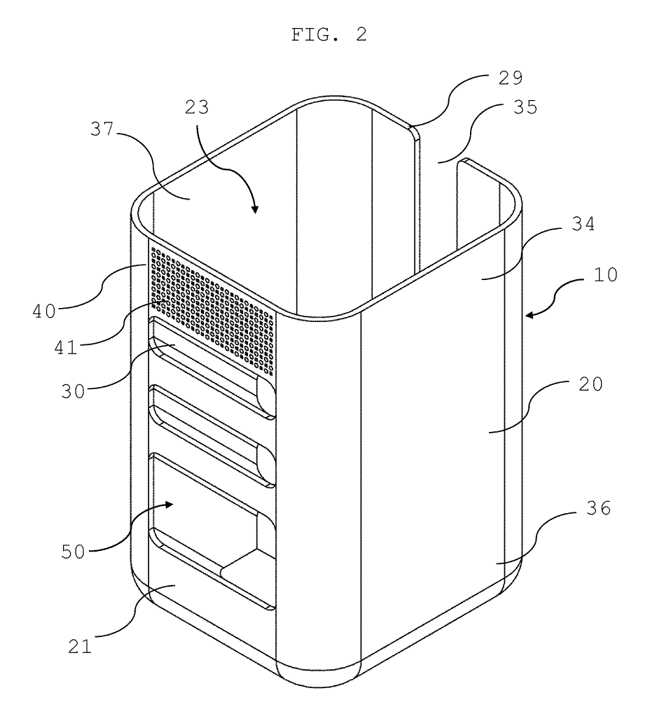

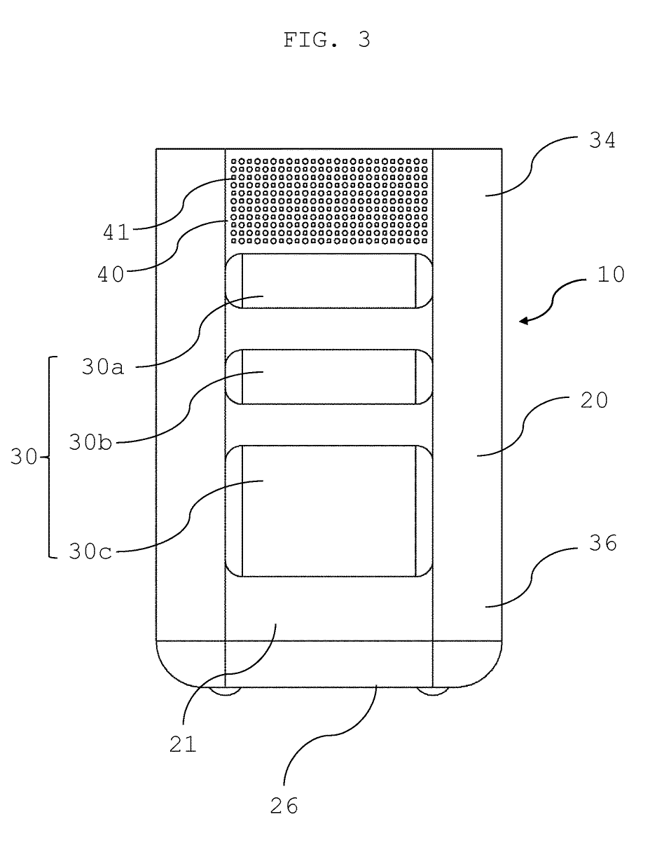

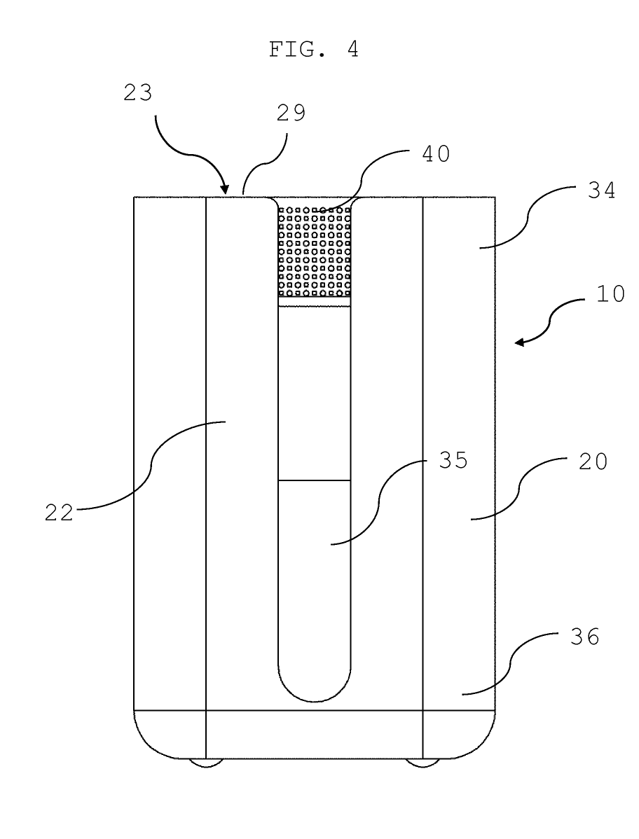

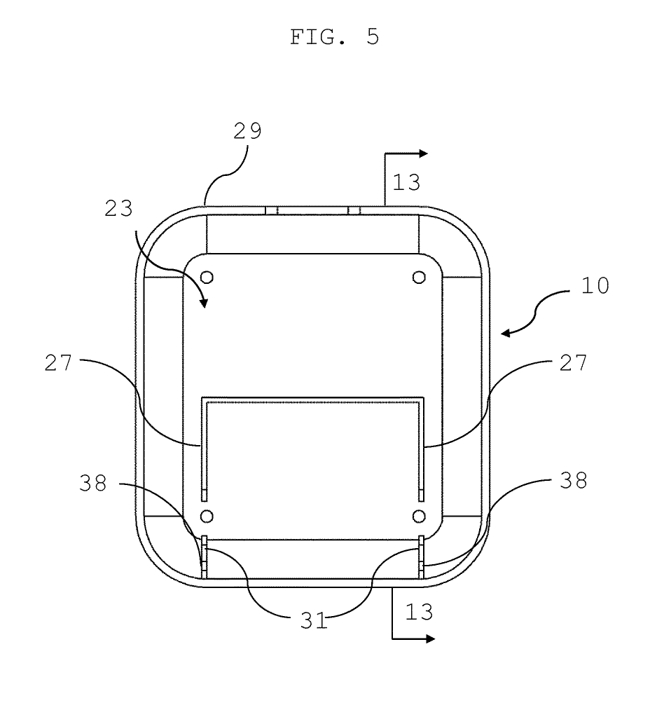

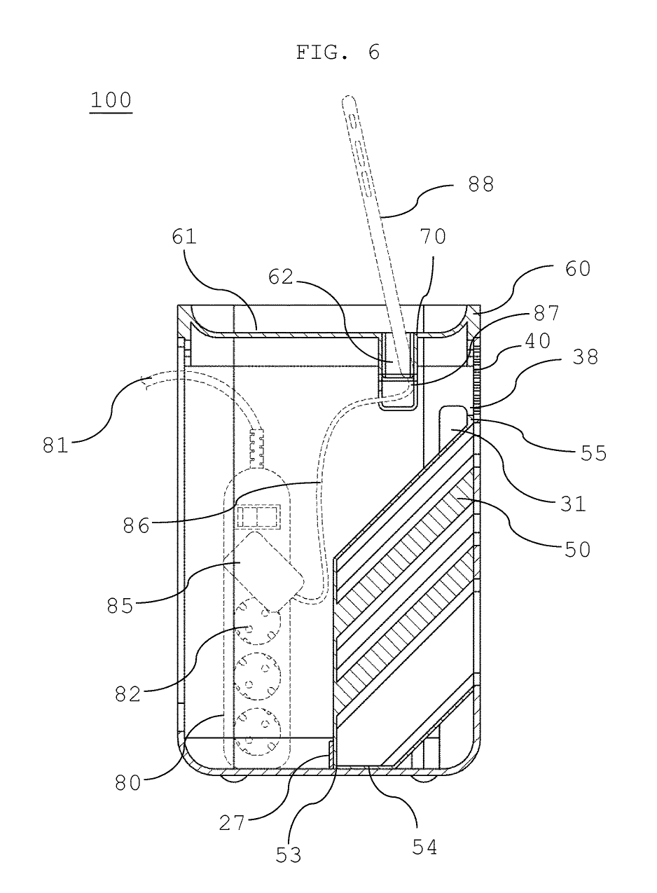

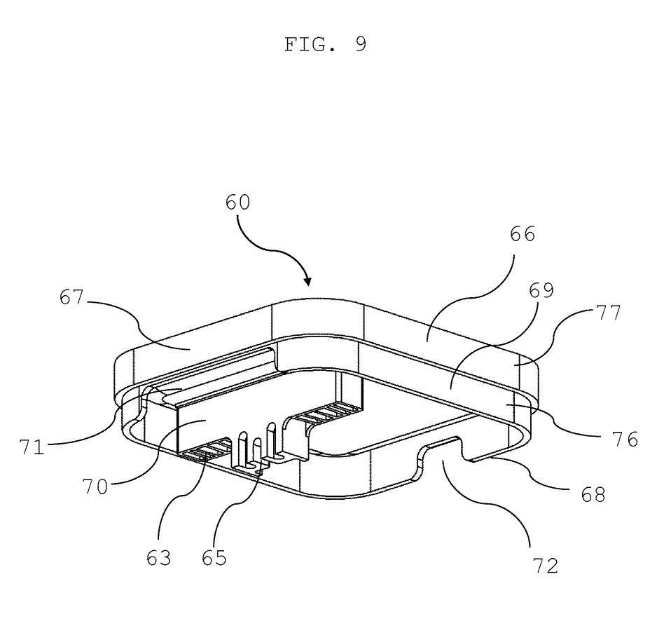

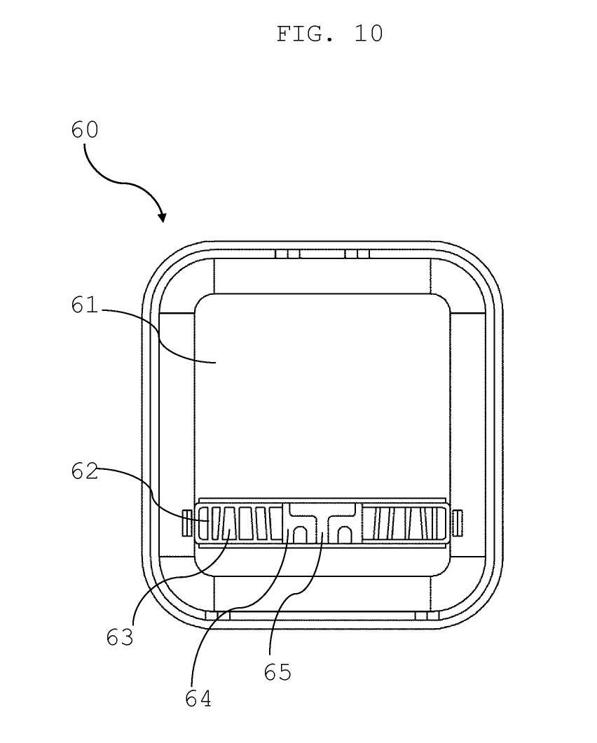

FIGS. 1 and 6 show perspective and cross-sectional views of the multi-purpose storage container 100 having a container body 10, a cover 60, and a storage compartment 50. FIGS. 2 and 3 show perspective and front views, rear and top plan views of the container body 10 and the storage compartment 50 of the multi-purpose storage container 100 assembled together. FIGS. 4 and 5 show rear and top plan views of the container body 10. FIGS. 9 and 10 respectively show a perspective view and a top plan view of the cover 60 having a charging stand 70.

The multi-purpose storage container 100 includes: a container body 10, having a sidewall 20 and a bottom 26, for receiving a power strip 80 and/or a charging adaptor 85; a cover 60 for covering a top opening 23 of the container body 10 wherein a charging stand 70 for an electronic device 88 may be formed on the cover; and a storage compartment 50, constructed to be removably received in the container body 10. A side opening 35 is formed on the sidewall 20 of the container body 10 so that a power cable 81 can pass through the side opening 35. The power strip 80 may have a power cable 81 and one or more power outlets 82.

In addition, as shown in FIG. 9, the charging stand 70 has a groove 62 formed on a top 61 of the cover 60 to receive the electronic device 88. The groove 62 of the cover 60 may include a plurality of holes 63 through which sound generated by the electronic device 88 can pass. Smart phones like iPhone™ have a speaker on its bottom and sound from the speaker can pass through the holes 63 since the holes 63 are close to the speaker.

As shown in FIG. 2, the container body 10 may include a sound-transmitting portion 40 formed on an upper portion 34 of the sidewall 20 of the container body 10 so that the sound generated by the electronic device 88 can pass through the sound-transmitting portion 40. Accordingly, sound generated from the speaker of the electronic device 38 passes through the holes 63 of the groove 620 and then through the sound-transmitting portion 40 to the outside of the multi-purpose storage container 100.

The sound-transmitting portion 40 may include a plurality of holes 41. The groove 62 and the sound-transmitting portion 50 are substantially parallel to each other. Preferably, the plurality of holes 41 may be in the form of circular holes, rounded rectangular holes, or so forth. Alternatively, the sound-transmitting portion 40 may be made of fabric, paper or other material through which sound can easily pass.

As shown in FIGS. 9 and 10, the charging stand 70 may further include a recess 64 formed on a bottom of the groove 62. The recess 64 of the charging stand 70 may include a cable hole 65 so that a connector 87 of the charging adaptor 85 can pass through the cable hole 65. Preferably, the cable hole 65 is “T”-shaped as in FIG. 10. The connector 87 is sized sufficient to pass through the “T”-shaped cable hole 65, but the length of the connector 87 is greater than the width of the cable hole 65 so that the connector 87 inserted into the cable hole 65 may not be slipped out the cable hole 65.

The cover 60 may further include a sidewall 66 and the sidewall 66 may include a cavity 69 formed on a peripheral lower portion 76 of the sidewall 66 of the cover 60. A front portion 67 and a back portion 68 of sidewall 66 of the case 60 may respectively include a first recess 71 and a second recess 72. Preferably, the first recess 71 of the front portion 67 of the sidewall 66 of the cover 60 may be located on the side where the sound-transmitting portion 40 is located. The second recess 72 of the back portion 68 of the sidewall 66 of the cover 60 may be located on the side where the cable opening 35 is located. Besides, the cavity 69 of sidewall 66 of the cover 60 may form a friction fit with the boundary of the opening 23 of the container body 10 for a secure coupling between the cover 60 and the container body 10. An upper portion 77 of sidewall 66 of the cover 60 may be flushed with the upper portion 34 of sidewall 20 of the container body 10.

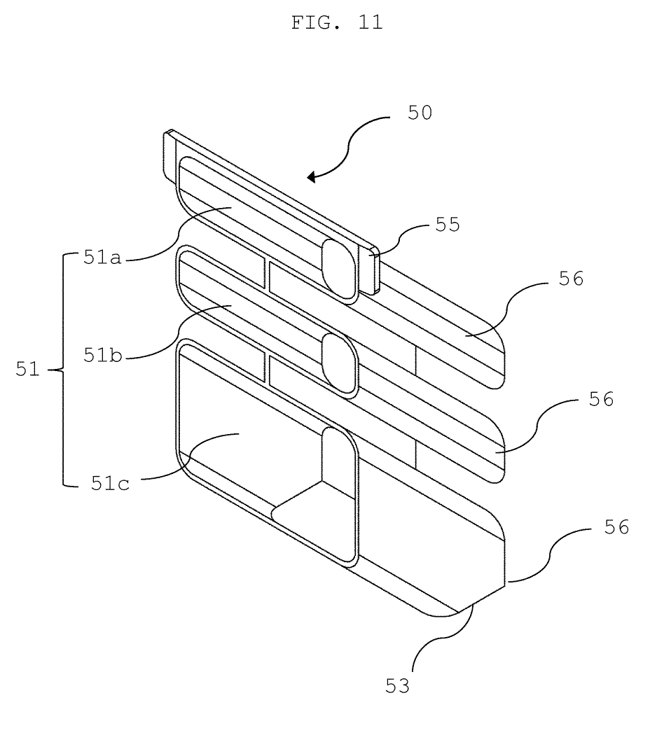

As shown in FIGS. 5, 6, 11, and 13, the container body 10 may include a pair of first fixing guards 31, wherein the storage compartment 50 may include a flange 55, and wherein a pair of receiving grooves 38 may be respectively formed on the first fixing guards 31 to receive both sides of the flange 55 for removably mounting the storage compartment 50 into the container body 10. The flange 55 may extend around one of the compartment openings 51 as in FIG. 11.

Furthermore, the container body 10 may further include a second fixing guard 27, fixedly attached to the bottom 26 of the container body 10, which may be “U”-shaped with substantially rectangular corners. The storage compartment 50 may be constructed to fit in a space formed by the second fixing guard 27 and the sidewall 20 of the container body 10. Once the storage compartment 50 is received in the space, it is securely kept in the space and does not horizontally move. Preferably, the second fixing guard 27 is “U”-shaped as shown in FIG. 5. Alternatively, the second fixing guard 27 may be comprised of two “L”-shaped members.

Besides, the container body 10 may include a container opening 30 formed on the sidewall 20 of the container body 10 and the storage compartment 50 may include a compartment opening 51 formed on a location substantially corresponding to the container opening 30 of the container body 10.

As shown in the FIG. 2, the side opening 35 of the container body 10 may be vertically and longitudinally formed on the sidewall 20 of the container body 10 up to the top opening 23 of the container body 10. Furthermore, the side opening 35 may be sized such that a power cable 81 can pass through the side opening 35, but the power strip 80 cannot pass through the side opening 35 even though the power strip 80 can pass through the top opening 23 of the container body 10 and be received in the container body 10. Thus, the power strip 80 can be inserted into container body 10 through the top opening 23 of the container body 10, however, once it is inserted and the cover 60 is closed to the top opening 23, the power strip 80 does not be taken out of the side opening 35. A charging adaptor 85 can be inserted into the container body 10 through the top opening 23 as well.

In another embodiment of the present invention, a multi-purpose storage container 100 may include a container body 10, having a sidewall 20 and a bottom 26, for receiving a power strip 80 and a charging adaptor 85, wherein the sidewall 20 may include a front sidewall 21 and a rear sidewall 22 both of which face each other; a cover 60 for covering a top opening 23 of the container body 10 wherein a charging stand 70 for an electronic device 88 may be formed on the cover; and a storage compartment 50, constructed to be removably received in the container body 10, having a plurality of sub-compartments 56. A side opening 35 may be formed on the rear sidewall 22 of the sidewall 20 of the container body 10 so that a power cable 81 can pass through the side opening 35. A sound-transmitting portion 40 may be formed on an upper portion 34 of the front sidewall 21 of the sidewall 20 of the container body 10 so that sound generated by the electronic device 88 can pass through the sound-transmitting portion 40. The power strip 80 has a power cable 81 and one or more power outlets 82.

As shown in the FIG. 3, the container body 10 may include the plurality of container openings 30 formed on the front sidewall 21 of the sidewall 20 of the container body 10 and wherein the storage compartment 50 may include the plurality of compartment openings 51 formed on locations respectively and substantially corresponding to each of the container openings 30 of the container body 10.

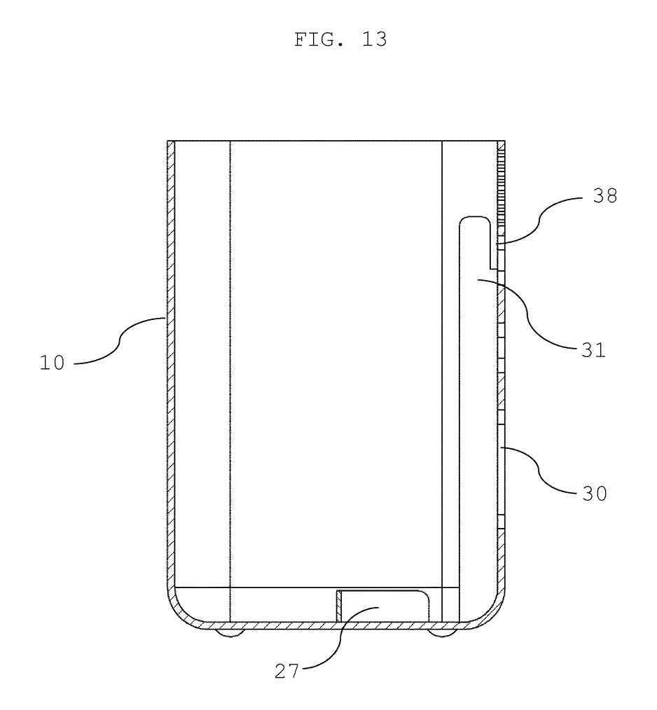

As shown in FIGS. 5 and 13, the container body 10 may include a pair of first fixing guards 31 fixedly attached to the front sidewall 21 of the sidewall 20 of the container body 10. In addition, the storage compartment 50 may include a flange 55 formed around one of the sub-compartments 56. A pair of receiving grooves 38 may be respectively formed on the first fixing guards 31 to receive both sides of the flange 55 for removably mounting the storage compartment 50 into the container body 10. The flange 55 may extend around one of the compartment openings 51 as in FIG. 11.

Furthermore, the container body 10 may further include a second fixing guard 27, fixedly attached to the bottom 26 of the container body 10, which may be “U”-shaped and have substantially rectangular corners. The storage compartment 50 may be constructed to fit in a space formed by the second fixing guard 27 and the front sidewall 21 of the sidewall 20 of the container body 10. Once the storage compartment 50 may be received in the space, it may be securely kept in the space and does not horizontally move. Preferably, the second fixing guard 27 is “U”-shaped as in FIG. 5. Alternatively, it 27 may comprise two “L”-shaped elements.

As shown in the FIGS. 6 and 9, the charging stand 70 may include a groove 62 formed on a top 61 of the cover 60 to receive the electronic device 88. The groove 62 may be substantially parallel to the front sidewall 21 of the sidewall 20 of the container body 10. Also, the groove 62 of the cover 60 may include a plurality of holes 63 through which the sound generated by the electronic device 88 can pass.

Furthermore, the charging stand 70 may further include a recess 64 formed on a bottom of the groove 62. The recess 64 of the charging stand 70 may include a cable hole 65 so that a connector 87 of the charging adaptor 85 can pass through the cable hole 65. Preferably, the cable hole 65 may be “T”-shaped.

As shown in FIG. 9, the cover 60 may further include a sidewall 66 of the cover 60, wherein the sidewall 66 may include a cavity 69 formed on a peripheral lower portion 76 of the sidewall 66 of the cover 60. A front portion 67 and a back portion 68 of sidewall 66 of the case 60 may include a first recess 71 and a second recess 72 respectively. Preferably, the first recess 71 of the front portion 67 of the sidewall 66 of the cover 60 may be located at the sound-transmitting portion 40. The second recess 72 of the back portion 68 of the sidewall 66 of the cover 60 may be located at the cable opening 35. Besides, the cavity 69 of sidewall 66 of the cover 60 may form a friction fit with the opening 23 of the container body 10 and wherein a upper portion 77 of sidewall 66 the cover 60 may be flushed with the upper portion 34 of sidewall 20 of the container body 10.

As shown in the FIG. 2, the side opening 35 is vertically and longitudinally formed on the sidewall 20 of the container body 10 up to the top opening 23 of the container body 10, and wherein the side opening 35 is sized such that a power cable 81 can pass through the side opening 35, but the power strip 80 cannot pass through the side opening 35 even though the power strip 80 can pass through the top opening 23 of the container body 10 and be received in the container body 10. Thus, the power strip 80 can be inserted into container body 10 through the top opening 23 of the container body 10, however, once it is inserted and the cover 60 is closed to the top opening 23, the power strip 80 does not be taken out of the side opening 35. A charging adaptor 85 can be inserted into the container body 10 through the top opening 23 as well.

While the invention has been shown and described with reference to different embodiments thereof, it will be appreciated by those skilled in the art that variations in form, detail, compositions, and operation may be made without departing from the spirit and scope of the invention as defined by the accompanying claims.

What is claimed is:

1. A multi-purpose storage container (100), comprising:
a container body (10), having a sidewall (20) and a bottom (26), for receiving a power strip (80) and/or a charging adaptor (85);
a cover (60) for covering a top opening (23) of the container body (10) wherein a charging stand (70) for an electronic device (88) is formed on the cover; and
a storage compartment (50), constructed to be removably received in the container body (10), wherein a side opening (35) is formed on the sidewall (20) of the container body (10) so that a power cable (81) can pass through the side opening (35).

2. The multi-purpose storage container (100) of claim 1, wherein the charging stand (70) comprises a groove (62) formed on a top (61) of the cover (60) to receive the electronic device (88).

3. The multi-purpose storage container (100) of claim 2, wherein the groove (62) of the cover (60) comprises a plurality of holes (63) through which sound generated by the electronic device (88) can pass.

4. The multi-purpose storage container (100) of claim 3, wherein the container body (10) comprises a sound-transmitting portion (40) formed on an upper portion (34) of the sidewall (20) of the container body (10) so that the sound generated by the electronic device (88) can pass through the sound-transmitting portion (40).

5. The multi-purpose storage container (100) of claim 4, wherein the sound-transmitting portion (40) comprises a plurality of holes (41) so that the sound generated by the electronic device (88) can pass through the plurality of holes (41).

6. The multi-purpose storage container (100) of claim 4, wherein the groove (62) and the sound-transmitting portion (50) are substantially parallel to each other.

7. The multi-purpose storage container (100) of claim 2, wherein the charging stand (70) further comprises a recess (64) formed on a bottom of the groove (62).

8. The multi-purpose storage container (100) of claim 7, wherein the recess (64) of the charging stand (70) comprises a cable hole (65) so that a connector (87) of the charging adaptor (85) can pass through the cable hole (65).

9. The multi-purpose storage container (100) of claim 1, wherein the container body (10) comprises a pair of first fixing guards (31), wherein the storage compartment (50) comprises a flange (55), and wherein a pair of receiving grooves (38) are respectively formed on the first fixing guards (31) to receive both sides of the flange (55) for removably mounting the storage compartment (50) into the container body (10).

10. The multi-purpose storage container (100) of claim 1, wherein the container body (10) further comprises a second fixing guard (27), fixedly attached to the bottom (26) of the container body (10), which is “U”-shaped with substantially rectangular corners, and wherein the storage compartment (50) is constructed to fit in a space formed by the second fixing guard (27) and the sidewall (20) of the container body (10).

11. The multi-purpose storage container (100) of claim 1, wherein the container body (10) comprises a container opening (30) formed on the sidewall (20) of the container body (10) arid wherein the storage compartment (50) comprises a compartment opening (51) formed on a location substantially corresponding to the container opening (30) of the container body (10).

12. The multi-purpose storage container (100) of claim 1, wherein the side opening (35) is vertically and longitudinally formed on the sidewall (20) of the container body (10) up to the top opening (23) of the container body (10).

13. The multi-purpose storage container (100) of claim 12, wherein the side opening (35) is sized such that a power cable (81) can pass through the side opening (35), but the power strip (80) cannot pass through the side opening (35) even though the power strip (80) can pass through the top opening (23) of the container body (10) and be received in the container body (10).

14. A multi-purpose storage container (100), comprising:
a container body (10), having a sidewall (20) and a bottom (26), for receiving a power strip (80) and/or a charging adaptor (85), wherein the sidewall (20) comprises a front sidewall (21) and a rear sidewall (22) both of which face each other;
a cover (60) for covering a top opening (23) of the container body (10) wherein a charging stand (70) for an electronic device (88) is formed on the cover; and
a storage compartment (50), constructed to be removably received in the container body (10), having a plurality of sub-compartments (56),
wherein a side opening (35) is formed on the rear sidewall (22) of the sidewall (20) of the container body (10) so that a power cable (81) can pass through the side opening (35),
wherein a sound-transmitting portion (40) is formed on an upper portion (34) of the front sidewall (21) of the sidewall (20) of the container body (10) so that sound generated by the electronic device (88) can pass through the plurality of holes (41).

15. The multi-purpose storage container (100) of claim 14-, wherein the container body (10) comprises the plurality of container openings (30) formed on the front sidewall (21) of the sidewall (20) of the container body (10) and wherein the storage compartment (50) comprises the plurality of compartment openings (51) formed on locations respectively and substantially corresponding to each of the container openings (30) of the container body (10).

16. The multi-purpose storage container (100) of claim 14, wherein the container body (10) comprises a pair of first fixing guards (31) fixedly attached to the front sidewall (21) of the sidewall (20) of the container body (10), wherein the storage compartment (50) comprises a flange (55) formed around one of the sub-compartments (56), and wherein a pair of receiving grooves (38) are respectively formed on the first fixing guards (31) to receive both sides of the flange (55) for removably mounting the storage compartment (50) into the container body (10).

17. The multi-purpose storage container (100) of claim 14, wherein the container body (10) further comprises a second fixing guard (27), fixedly attached to the bottom (26) of the container body (10), which is “U”-shaped and has substantially rectangular corners, and wherein the storage compartment (50) is constructed to fit in a space formed by the second fixing guard (27) and the front sidewall (21) of the sidewall (20) of the container body (10).

16. The multi-purpose storage, container (100) of claim 14, wherein the charging stand (70) comprises a groove (62) formed on a top (61) of the cover (60) to receive the electronic device (88),
wherein the groove (62) is substantially parallel to the front sidewall (21) of the sidewall (20) of the container body (10), and
wherein the groove (62) of the cover (60) comprises a plurality of holes (63) through which the sound generated by the electronic device (88) can pass.

19. The multi-purpose storage container (100) of claim 18, wherein the charging stand (70) further comprises a recess (64) formed on a bottom of the groove (62), and
wherein the recess (64) of the charging stand (70) comprises a cable hole (65) so that a connector (87) of the charging adaptor (85) can pass through the cable hole (65).

20. The multi-purpose storage container (100) of claim 14, wherein the side opening (35) is vertically and longitudinally formed on the sidewall (20) of the container body (10) up to the top opening (23) of the container body (10), and
wherein the side opening (35) is sized such that a power cable (81) can pass through the side opening (35), but the power strip (80) cannot pass through the side opening (35) even though the power strip (80) can pass through the top opening (23) of the container body (10) and be received in the container body (10).
